(19) United States
(12) Patent Application Publication
(10) Pub. No.: US 2014/0062692 A1
(43) Pub. Date: Mar. 6, 2014

(54) Motion Detector with Shock Detection

(71) Applicants: Huayu LI, Bao An District (CN); Tianfeng Zhao, Nanshan District (CN); Lei Qin, LongGang District (CN)

(72) Inventors: Huayu LI, Bao An District (CN); Tianfeng Zhao, Nanshan District (CN); Lei Qin, LongGang District (CN)

(73) Assignee: Honeywell Inernational Inc., Morristown, NJ (US)

(21) Appl. No.: 13/604,137

(22) Filed: Sep. 5, 2012

(51) Int. Cl. G08B 19/00; G08B 13/16

(52) U.S. Cl. 340/521; 340/566

(57) ABSTRACT

Apparatus is provided including an environmental sensor that detects security threats within a secure area, a shock detector that detects vibration of the environmental sensor and a processor that receives an signal from the environmental detector, processes the signal and provides a threat detected signal in response to the signal from the environmental detector wherein the processor also processes a signal from the shock detector, detects vibration and blocks the threat detected signal during the detected vibration.

### FIELD

The field of the invention relates to intrusion detection devices and more particularly to passive infrared sensors.

### BACKGROUND

Passive infrared (PIR) sensors or passive infrared detectors (PIDs) are generally known. Such devices find ready use as intrusion detectors in security systems.

A PID device detects intrusion via the infrared radiation emitted by humans. However, PID devices suffer from the difficulty of not being able to differentiate between humans and animals or in not being able to detect humans against hot background surfaces.

One particular type of PID devices is a PID motion detector. A PID motion detector uses a pair of infrared detectors arranged to scan adjacent areas. In this regard, the pair of detectors may be connected in series so that when both areas have the same background temperature, the signal from the one will cancel the signal from the other.

PID motion detectors have been found to be considerably more reliable than when PID detectors are used individually. Since the PIDs of a motion sensor are connected to cancel one another, motion detectors are less vulnerable to transients. For example, flashes of light (e.g., lightning) detected by the pair of detectors is canceled.

Moreover, if a human should appear in one of the two areas, the PID detector on that side would detect the human via the difference in temperature between the human and the background. More importantly, when the human passes from the first of the pair of adjacent areas to the second area, the signal from the pair of detectors will reverse thereby indicating a direction of travel of the human through the pair of areas.

While PID motion detectors are a significant improvement, they are still subject to false alarms. Accordingly, a need exists for more reliable PID motion detectors.

### BRIEF DESCRIPTION OF THE DRAWINGS

FIG. 1 is a simplified block diagram of an optical environmental sensing device shown in a context of use;

FIG. 2 shows waveforms used by the device of FIG. 1;

FIG. 3 is a flow chart of steps that may be used by the device of FIG. 1; and

FIG. 4 is particular example of the device of FIG. 1.

### DETAILED DESCRIPTION OF AN ILLUSTRATED EMBODIMENT

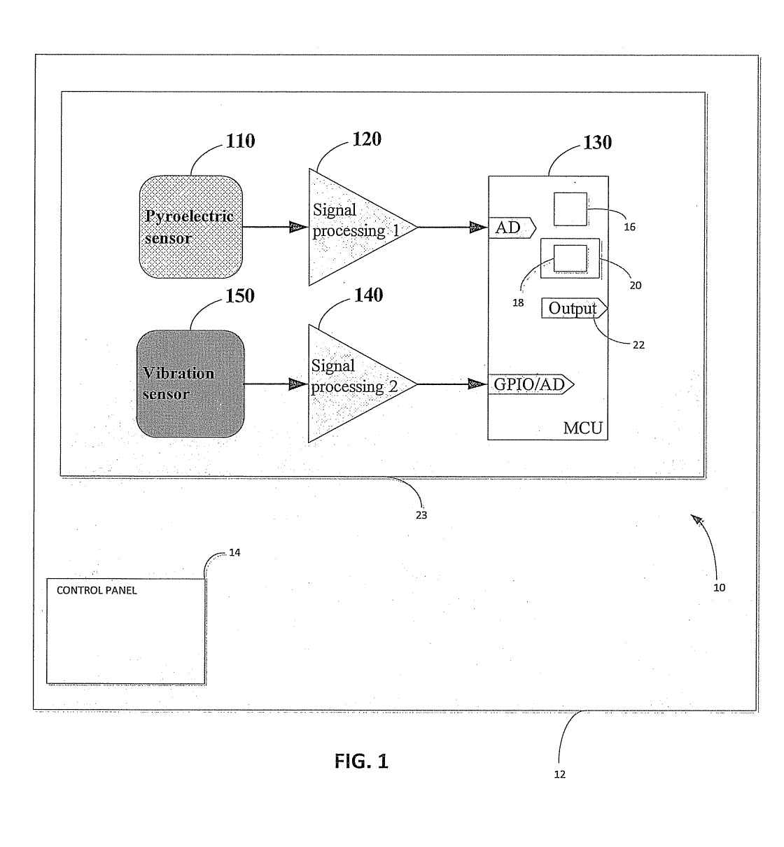

FIG. 1 is a simplified block diagram of an optical environmental detector 10 shown generally in accordance with an illustrated embodiment. The environmental sensor 10 may be a PIR motion sensor, a dual-tech (PIR and microwave) sensor, a glass breakage sensor, a smoke sensor, etc. Under the illustrated embodiment, the detector 10 may be connected to a security system and used to detect threats within a secured area 12.

Under one illustrated embodiment, the environmental detector 10 may be provided with one or more optical or sound sensors 110, a vibration or shock sensor 150, a processor 130 and signal processing devices (e.g., amplifiers, filters, etc.) 120, 140. The sensor 110 and vibration sensor 150 may be physically attached to a housing 23 of the PID sensor 10.

The micro processing unit 130 depicted in FIG. 1 may be any appropriate combination of hardware devices (e.g., processors, memory, communication interfaces such as modems or wireless transceivers, power supplies, etc.). Under one illustrated embodiment, the processor 130 includes or more computer processors (e.g., made by Intel) 16 operating under control of one or more computer programs 18 loaded from a non-transitory computer readable medium (memory) 20.

In one particular example, the device 10 may be a PIR motion sensor. In this example, the processor 130 receives signals from the one or more PIR sensors 110 and from the vibration sensor 150 and each time the PID motion detector 10 detects an intruder within the secured area 12, the processor 130 sends a motion detected message to a control panel 14 of a security system that protects the secured area 12. The control panel may respond by triggering a local audible or visual alarm and/or notify a local police department.

It has been found that optical (e.g., PID motion) sensors are vulnerable to false alarms triggered by vibration or mechanical shock. Vibration or shock in this case may be created by a person striking the wall on which the PID motion sensor is mounted or slamming a door in the area of the sensor.

Under an illustrated embodiment, the PIR motion detector 10 has at least two operating modes including a first mode where the detector 10 operates under control of the PIR detectors 110 and a second mode where the output of the detectors 110 are blocked. Control of the modes of the detector 10 may be based upon signals processed by one or more of the programmed processors 16 of the processing unit 130.

In this regard, a mode processor of the processing unit 130 may receive signals from one or more signal processors coupled to each of the PIR sensors 110 and vibration sensors 150 and respond accordingly. For example, one of the signal processors may be a PID signal level processor that receives signals from the PID sensors 110, filters and compares the output with a detection threshold to detect the presence of an intruder. The mode processor may also monitor the output of the signal level processor for a signal reversal indicating a direction of travel of the intruder. In the first mode, the mode processor may transmit a message indicating the presence and direction of travel of the intruder through the output 22 of the detector 10 to the control panel 14.

Another one of the signal processors may be a vibration processor that receives signals from the vibration sensor 150 and that processes these signals to determine a type and severity of the vibration. Based upon the type and severity of the vibration, the mode processor may cause the motion detector 10 to switch between the first and second modes.

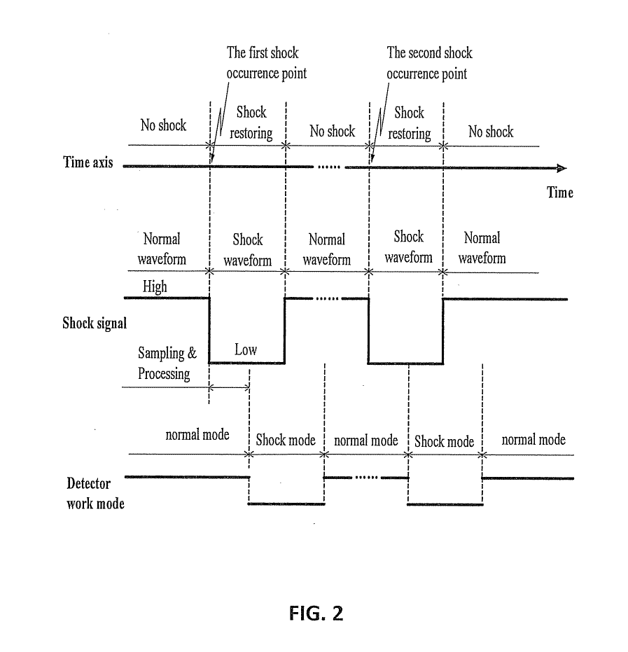

FIG. 2 depicts a set of signal processing features of the processing unit 130. The uppermost line (labeled “Time Axis”) depicts an input to the signal processor that monitors the vibration sensor 150. The middle line depicts an output of the vibration processor in response to processing the vibration signal on the uppermost line.

The bottom line of FIG. 2 represents an output of the mode processor. As may be noted from FIG. 2, the normally high signal of the vibration processor may transition to a low level at the beginning of the shock event and remain there for the duration of the shock event as may be seen by comparing the bottom line with the middle line of FIG. 2. The mode processor may have a slight delay based upon sampling and processing times.

As shown in the bottom line of FIG. 2, the mode processor outputs a negative going pulse in response to the shock event detected by the vibration processor. The negative going pulse provided by the mode processor may have the same length of time as the duration of the shock waveform (albeit delayed in time by the sampling and processing time) or may have a longer or shorter time based upon the type of shock event detected. The negative going pulse from the mode processor may be used to block the intrusion detection signal from the PID sensors 110. This may be performed directly by disabling the output 22 or executing a logical Boolean equation (A+B=C, where C is the output, A is the PID sensor 110 and B indicates no vibration the vibration sensor 150). Alternatively, the negative going pulse of the vibration processor may simply cause the mode processor to simply ignore any signal provided by the signal level processor from the PID sensors 110.

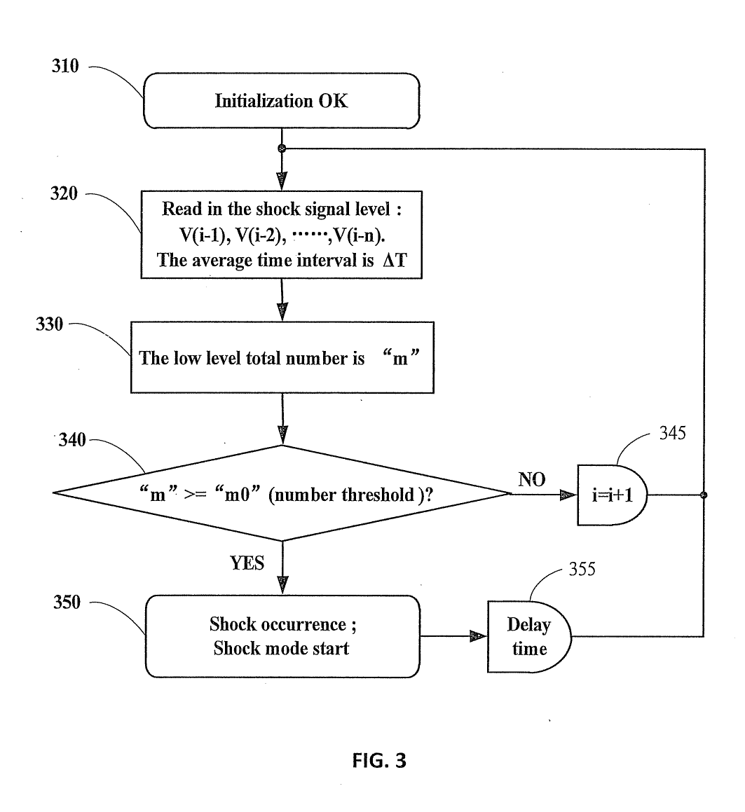

FIG. 3 depicts a set of steps that may be followed by the vibration processor in detecting vibration. In this regard, once initialized 310, the vibration sensor 150 may be continually monitored. In the case, the vibration processor or associated sampling processor may sample 320 the output of the vibration sensor 150 at some appropriate interval (e.g., 3 kHz).

In the case where the vibration detector 150 is an analog device (e.g., an accelerometer), the processor may use a voltage method that compares the amplitude of the voltage of each sample with a vibration threshold value. Alternatively, a level method may be used where the vibration detector 150 is digital device that provides a contact closure type of output for each sample above a threshold value (i.e., each time the vibration detected by the vibration detector 150 exceeds a threshold value). In either case, the vibration processor may collect the number of samples (m) above the threshold for each time period into a sample file. After each sample above the threshold is added to the file, the processor increments a counter 345 and processes the next sample.

At the end of the time period, a comparator of the processor may compare 340 the number (m) of samples above the threshold value during the time period with a vibration activity threshold value. If the number (m) of samples above the threshold value exceeds the activity threshold value, then the processor may instruct the mode processor to enter the second mode blocking the output of the PID motion sensor 10. If the number of samples (m) is below the activity threshold, then the process repeats.

Under another illustrated embodiment, the vibration processor includes an averaging processor that averages the magnitude of a set of accelerometer readings over some number of samples (time m). In this case, if the number of samples averaged is less than m, then the vibration process selects 345 another sample and the process repeats. At the end of the time period m, the average is compared with a vibration amplitude threshold value. If the average is above the threshold then, the device 10 goes into the second mode, blocking the PID motion detection output. If not, then the process repeats.

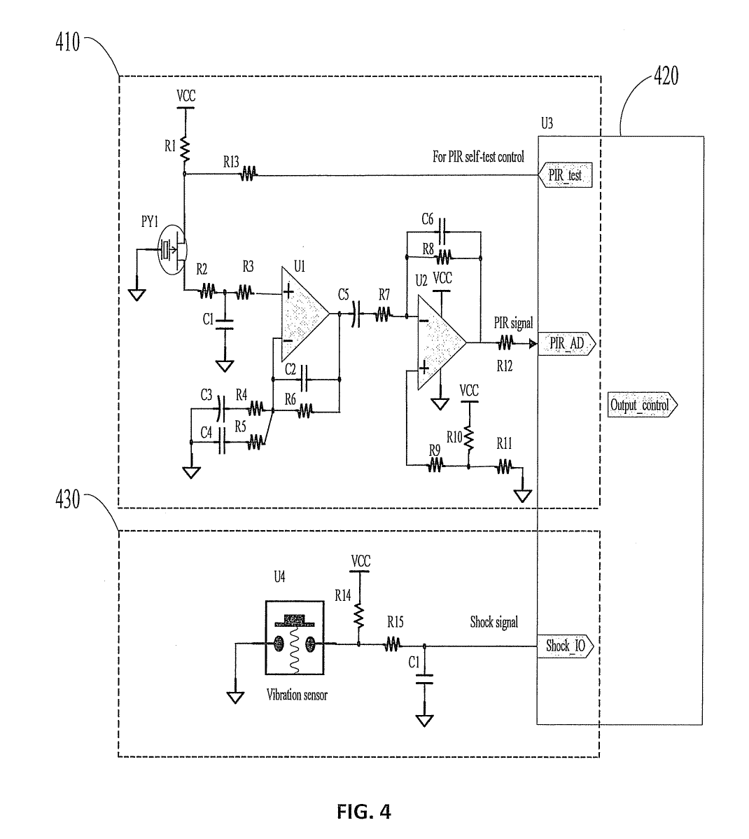

FIG. 4 depicts a specific example of the PID motion detector under one illustrated embodiment. As with FIG. 1, FIG. 4 shows only a first PIR sensor (PY1). In FIG. 4 a first high frequency filter (resistors and capacitors coupled to U1) couples a PIR signal to a second lower frequency filter (resistors and capacitors coupled to U2).

In a motion detector 10, the first PIR sensor 410 would be directed to a first portion of the secured area 12. A second PIR sensor 410 would also be used to cover a second portion of the secured area 12 directly adjacent to the first portion.

As noted above, a first set of signal processors (of the processing unit 420) would be coupled to the PIR sensors 410 covering the first portion of the area 12 and a second (or same) set of signal processors (of the processing unit 420) would be coupled to the PIR sensor 410 covering the second portion of the area 12. A comparator would receive the processed signals from the first and second set of signal processors and process the signals to detect intruders and direction of travel of the intruders based upon the signal changes from the two PIR detectors 410.

FIG. 4 also shows a vibration sensor 430. It should be noted in this regard that three sensors 430 would be needed to detect shock in the three possible dimensions of vibration.

Signals from the PIR sensors 410 and vibration sensors 430 may be processed as discussed above. In the case where three vibration sensors 430 are used, then a first threshold may be used for each individual sensor 430 to trigger the transition to the second mode as well as a cumulative threshold that is compared to the sum of the values from the three sensors 430 to trigger blocking of the output.

The motion detector 10 provides an advance in the technology of environmental detection on any of a number of different levels. The techniques described above in conjunction with FIGS. 1-4 are easy to implement. The addition of a shock sensing element is more stable that filtering on its own. The sample processing of the signal from the shock sensor is simple and effective.

In general, the environmental detector 10 includes an environmental sensor that detects security threats within a secure area, a shock detector that detects vibration of the environmental sensor and a processor that receives an signal from the environmental detector, processes the signal and provides a threat detected signal in response to the signal from the environmental detector wherein the processor also processes a signal from the shock detector, detects vibration and blocks the threat detected signal during the detected vibration.

In other embodiments, the environmental detector includes a passive infrared sensor that detects intruders within a secure area, a shock detector that detects vibration of the passive infrared sensor and a processor that receives an signal from the passive infrared sensor, processes the signal and provides an intruder detected signal in response to the signal from the passive infrared sensor wherein the processor also processes a signal from the shock detector, detects vibration and blocks the intruder detected signal during the detected vibration.

In still other embodiments, the environmental detector includes a pair of passive infrared sensors that detect intruder motion, a shock detector that detects vibration of the passive infrared sensors and a mode processor that receives an intruder detected signal from the passive infrared sensors and a signal from the shock detector, provides a motion detected signal as an output in response to the signal from the passive infrared sensors and blocks the motion detected signal upon detecting vibration from the shock detector.

Although a few embodiments have been described in detail above, other modifications are possible. For example, the logic flows depicted in the figures do not require the particular order shown, or sequential order, to achieve desirable results. Other steps may be provided, or steps may be eliminated, from the described flows, and other components may be added to, or removed from, the described systems. Other embodiments may be within the scope of the following claims.

1. Apparatus comprising:
an environmental sensor that detects security threats within a secure area;
a shock detector that detects vibration of the environmental sensor; and
a processor that receives an signal from the environmental detector, processes the signal and provides a threat detected signal in response to the signal from the environmental detector wherein the processor also processes a signal from the shock detector, detects vibration and blocks the threat detected signal during the detected vibration.

2. The apparatus as in claim 1 wherein the environmental sensor further comprises one of a passive infrared intrusion detection device, a dual-tech intrusion detection device based upon passive infrared and microwave sensors, a glass breakage detector and a smoke detector.

3. The apparatus as in claim 1 wherein the environmental sensor further comprises a pair of passive infrared detectors arranged to detect the motion of intruders within the secure area.

4. The apparatus as in claim 1 further comprising the processor that receives an signal from the passive infrared detectors, processes the signals and provides an intruder detected signal in response to the signals from the passive infrared detectors wherein the processor also processes a signal from the shock detector, detects vibration and blocks the intruder detected signal during the detected vibration.

5. The apparatus as in claim 1 wherein the vibration detector further comprises an accelerometer.

6. The apparatus as in claim 1 wherein the vibration detector further comprises a digital device that provides a contact closure each time the vibration detected by the vibration detector exceeds a threshold value.

7. The apparatus as in claim 6 further comprising a processor that counts the number of contact closures per time period and disables the environmental sensor upon detecting that the number exceeds a threshold value.

8. Apparatus comprising:
a passive infrared sensor that detects intruders within a secure area;
a shock detector that detects vibration of the passive infrared sensor; and
a processor that receives an signal from the passive infrared sensor, processes the signal and provides an intruder detected signal in response to the signal from the passive infrared sensor wherein the processor also processes a signal from the shock detector, detects vibration and blocks the intruder detected signal during the detected vibration.

9. The apparatus as in claim 8 wherein the passive infrared sensor further comprises a pair of passive infrared detectors that provide motion detection.

10. The apparatus as in claim 8 further comprising a comparator that compares the signal from the shock detector with a threshold value.

11. The apparatus as in claim 10 further comprising a processor that samples the signal from the shock detector.

12. The apparatus as in claim 11 further comprising a counter that counts the number of consecutive samples above the threshold value and that blocks the intruder detected signal upon detecting that the number of consecutive samples above the threshold value exceeds a threshold sample value.

13. The apparatus as in claim 11 further comprising a processor that averages a magnitude of the vibration over consecutive samples from the shock detector.

14. The apparatus as in claim 13 further comprising a comparator that compares the average magnitude with a threshold value.

15. The apparatus as in claim 14 further comprising a counter that counts the number of consecutive samples above the threshold value and that blocks the intruder detected signal upon detecting that the number of consecutive samples above the threshold value exceeds a threshold sample value.

16. Apparatus comprising:
a pair of passive infrared sensors that detect intruder motion;
a shock detector that detects vibration of the passive infrared sensors; and
a mode processor that receives an intruder detected signal from the passive infrared sensors and a signal from the shock detector, provides a motion detected signal as an output in response to the signal from the passive infrared sensors and blocks the motion detected signal upon detecting vibration from the shock detector.

17. The apparatus as in claim 16 further comprising a housing supporting the pair of passive infrared detectors and the shock detector.

18. The apparatus as in claim 17 wherein the shock detector further comprises a digital device that provides a contact closure each time the vibration of the housing exceeds a threshold value.

19. The apparatus as in claim 18 further comprising a counter that counts the number of contact closures per time period.

20. The apparatus as in claim 19 further comprising a comparator that compares the number of contact closures with a threshold value and signals the mode processor that vibration has been detected each time the number exceeds the threshold.
